(19) United States
(12) Patent Application Publication
(10) Pub. No.: US 2010/0058822 A1
(43) Pub. Date: Mar. 11, 2010

(54) Method for Making Highly Efficient, Low-Pollution, Slowly Nitrogen Releasing Organic Mineral Granular Fertilizers

(75) Inventor: Enrica Bargiacchi, Rosignano Marittimo Livorno (IT)

Correspondence Address: HEDMAN & COSTIGAN P.C., 1185 AVENUE OF THE AMERICAS, NEW YORK, NY, 10036, US

(73) Assignee: SADEPAN S.r.l., Viadana (Mantova) (IT)

(21) Appl. No.: 11/992,998

(22) PCT Filed: May 23, 2006
(86) PCT No.: PCT/IT2006/000388

§ 371 Date: Jul. 15, 2008

(30) Foreign Application Priority Data
Oct. 7, 2005 (IT) MI2005 A 001892

(51) Int. Cl. C05F 1/00; C05F 11/00

(52) U.S. Cl. 71/17; 71/27; 71/18; 71/19; 71/22

(57) ABSTRACT

A method for making highly efficient, low pollution, slowly nitrogen releasing organic mineral granular fertilizers comprising the step of mixing, in a liquid phase, a natural organic nitrogen containing fertilizer, a synthetic nitrogen containing fertilizer, and tannin and non-tannin organic extracts, and the step of drying the thus made mixture.

### BACKGROUND OF THE INVENTION

The present invention relates to a method for making highly efficient, low-pollution, slowly nitrogen releasing organic mineral granular fertilizers.

A main and important component of a vegetable biomass comprises tannin, i.e. a group of phenolic compounds very common in vegetable substances (such as pteridophyte, gymnosperms, angiosperms), included in fruit, barks and, particularly, in wood materials.

Their classification is not easy, because of the compound variability; however, two main classes are universally defined: hydrolyzable tannins and condensate tannins.

Hydrolyzable tannins are constituted by gallic acid ester compounds (gallotannins) and ellagic acid ester compounds (ellagitannins) with a sugar, usually consisting of glucose, and they can be hydrolyzed by acids or enzymes into monomeric products.

The condensate tannins, which are also called proantocyanidnes or polyflavonoids (PA), comprise a polyhydroxyflavonol polymer group, with C—C bonds between their sub-units.

As the information related to the structure of the above mentioned products increases, the above mentioned distinction tends to be lost since also the condensate tannins can contain esterified gallic acid at the C-ring 3-OH level.

The main feature determining the properties of the tannins seems to be the unusual high local concentration of ortho-phenolic hydroxyl groups.

In hydrolizable tannins, the latter are mainly associated with gallic or ellagic acid derivatives. In the condensate tannins (such as procyanidins and prodelphinidins) the same function is provided by the B-ring phenolic hydroxyls, (in which also the esterified gallate can provide a contribution).

In general, hydrolizable tannins are biologic agents having, for a unit mass, a power larger than that of condensate tannins, and the protein precipitating capability of these tannins is directly related to the number of galloyl groups.

Thus, this property makes them suitable to form large compounds, mainly with proteins, but also with other macromolecules, such as cellulose and pectins.

The non reversing reaction with proteins is a very interesting one, since it allows proteins to precipitate from solutions.

This property just represents the basic feature for using them in industrial applications, such as in vegetable tanning substances.

The non-tannin material comprises sugars, mainly penthosans (9-23%), such as xylose and ribose; oligosaccharids, and in particular xyloglucan and xilane, but also arabinogalactane; as well as hexosans (4-13%), such as mannan and hemicelluloses (arabogalactans, mainly in conifers).

Other important components comprise organic acids, such as: acetic, oxalic, malic, tartaric, lactic, piruvic, glyceric, glycolic, citric and isocitric, ascorbic, oxalacetic, succinic acids and so on.

At present, urea represents the nitrogenous fertilizer having the utmost use and diffusion throughout the world.

However, it can involve losses due to the soil-culture system.

The mentioned losses are related, firstly, to a volatilization of ammonia because of surface applications and, secondly, to an excessively quick nitrification of ammonia compounds derived from the first urea degradation; in fact nitrates, if they are not intercepted by the plant, are lost through the gravitational water passing through the soil, to generate large polluting sources.

In order to improve the agronomic efficiency of the urea, various correcting technological

approaches of this fertilizer have been proposed over time, both in solid and liquid form, with substances that modified the releasing time thereof or in any effect increased its agronomic efficiency.

The addition of inhibitors of nitrification and of urease, the development of phosphoric urea-acid adducts (characterized by delayed hydrolysis of the urea and low risk of phytotoxicity from free ammonia, as a result of the acidity induced by the phosphoric acid component), coating with sulphur or with pellicular substances of various origins and already used for some time.

The interest in preserving natural resources has promoted also research studies aimed at preparing slowly nitrogen releasing fertilizers. Among these, condensation products of urea with formaldehyde, isobutiraldehyde, crotonilaldehyde are recalled.

A process is already known for the production of N-lignin with title in N 22-30%, obtain by oxidative ammoniation, and subsequent neutralization with nitric acid, of refluent lignosulphonates of the paper industry.

Already present on the market is an organic-mineral fertilizer NPK with mineral nitrogen and amino groups of biological origin (for example, amino acids from molasses or proteinic hydrolysates), in which, in addition to a mono and disaccharide component, among which, glucose, fructose, galactose, xylose, saccharose and maltose, also a series of micro elements can be found, among which: boron, copper, manganese, zinc, iron, cobalt and molybdenum.

Nevertheless in this product no tannin and non tannin organic extracts, urea and its condensation products with aldehydes, together with amino groups of biological origin are simultaneously present.

Also known is the production of a “carbon/skeleton” energetic component based product and a macro nutritive component with at least one source of nitrogen or of phosphor soluble in water. In this product the concentrations of NP are lower than 0.625% by weight of N and P; the energetic component falls within a proportion comprising between 0.625 and approximately 8.785% by weight, while the cationic micro elements are in concentrations useful only for the copper (from 0.00025 to 0.0125% by weight of soluble Cu). Utilized for the other micro elements are concentrations between: 0.1÷3.0% (Fe); 0.08÷3.0% (Mn); 0.1÷3.0% (Zn) by weight.

Known also is a composition in solid form based on at least two micro elements, selected in the Cu, Mn, Zn, Co and Mo groups, which are added as salts to a nitrate soluble in water (salified with an element different from the added micro elements).Various organic, natural and synthetic ligands can be added to this base compound, such as bran and wheat meal, sawdust, polysaccharides and their derivatives, such as starch, starch derivatives, cellulose and its derivatives, alginates, lactose, mannitol or sorbitol such as gelatine, gum arabica, polyethylene glycol and polyvinyl pyrrolidone.

Nevertheless, the use of tannin and non tannin organic extracts, of urea and its products of condensation with aldehydes and amino groups of biological origin is not provided for simultaneously.

Already described is a particular method of concentration of leachates that has permitted to obtain aqueous solutions of tannin and non tannin with a ratio between (5÷0.6):1 and dry variable from 3 to 50%.

These aqueous solutions can be concentrated further until dry.

According to the present invention, a range of highly efficient, low pollution, slowly nitrogen releasing granular organic-mineral fertilizers can be formulated by mixing in liquid step of a fertilizer containing natural organic nitrogen, a fertilizer containing synthetic nitrogen and tannin and non tannin organic extracts and subsequent drying of the mixture thus obtained.

The drying step can take place by means of spray-dry or other granulation processes.

The fertilizers containing organic nitrogen may be: dry blood, meat meal and other animal derivatives and/or proteinic hydrolysates, of both animal and vegetable origin.

For their high protein content, these products act in the soil releasing the nitrogen gradually.

At the same time, the slightly acidifying action helps to maintain the phosphates and the micro elements in an available form to be more easily assimilated by the plant.

The products according to the present invention are moreover capable of transmitting the iron of the hemoglobin, for a lasting return to green effect.

In soil having low biological fertility, i.e. poor in organic substances, too sandy or salty, these products assist the useful microbe strains and maintain the nitrogen in available form, reducing losses to a minimum.

The fertilizers containing synthetic nitrogen can be: urea and its adducts, urea condensed with aldehydes, ammonium salt.

The tannin and non tannin organic extracts have a ratio (5÷0.6):1 between tannin and non tannin and dry variable between 3 and 50%, and are obtained by leaching in wood water and subsequent cold concentration of the leachates.

The combined presence of the “tannin” component and great quantities of the “non tannin”, composed of compounds such as: sugars, organic acids, salts and micro elements in a very acid ambient (pH=3.0÷4.0), as well as representing a direct source of low cost nutritive principles, provides also the opportunity to efficiently transmit further fertilizing effect substances that can be added to the mentioned organic extracts.

These substances are essentially nitrogen and micro element compounds, better defined hereinafter.

Moreover, the presence of “non tannins” in the organic extracts improves the microbiological activity of the soil and, more generally, the nutrition of the plant and the composition of its biomass.

Indeed as a result of the markedly acid pH, the aforementioned organic extracts, after repeated applications, are capable of modifying the soil reaction, avoiding the progressive alkalinization thereof, as occurs after agricultural activity. Added to water, also in low concentration, they reduce the pH thereof, taking it towards an interesting acidity condition.

In this regard, it is necessary to specify that the interest relative to acidifying solutions of the soil and of the waters of natural origin is considerable, as every increasing segments of agriculture are turning to methods of biological production, as defined in the EEC regulation 2092/91 and its subsequent amendments and integrations.

These methods exclude a priori the use of mineral acids; they tolerate, in some limited cases, the use of synthetic organic acids, such as citric, and permit as acidifying corrective of the soil only elementary sulphur or its suspensions in water, which is a product defined by the 76/116/EEC directive, amended by the 89/284/EEC directive.

The use of the tannin and non tannin organic extracts also offers the opportunity of an improved management of the calcareous waters (fertiirrigation), also outside the biological agricultural regime, and of saline soils, both in biological regime and traditional agriculture, as will be illustrated later.

Advantageously, added to these extracts is a nitrogen fertilizer, or its solutions or suspensions, so that the sum of the concentrations of tannin and non tannin in the fertilizer thus obtained reaches the maximum value of 90% (by weight), while that of nitrogen (N) results in the range of 3÷45% (by weight).

The embodiments of solid fertilizers provided by the present invention are obtained: (a) by mixing of the nitrogen component, preferably urea-formaldehyde, with a source of amino groups of biological origin and with tannin and non tannin organic extracts and subsequent drying of the mixture in an air current; (b) by coating of the dry nitrogen component, preferably urea-formaldehyde, with a source of amino groups of biological origin and with dry tannin and non tannin organic extracts.

In these cases, the production process may or may not provide the use of a wide series of products (animal gelatine, etc.) to assist the mixing and coating thus described.

The addition of a nitrogen fertilizer, preferably urea-formaldehyde to the tannin and non tannin organic extracts, as such or dried urea-formaldehyde, associated with a biologic origin aminic group source, provides a fertilizer which, in a solution, has a moderately acid pH (from 5.0 to 6.5 depending on the embodiments thereof). This will reduce the nitrogen losses due to the amonia volatilization, while minimizing the fertilizer aggressiveness with respect to the seeds, young roots and leaf apparatus of the processed plants (a less phytotoxicity with respect to the other nitrogenous fertilizers).

The presence of several residues of gallic and ellagic acids, as present in tannin and non-tannin organic extracts, tends to reduce the nitrification process speed at a first step after the application of the nitrogenous fertilizer to the ground, and this will contribute to characterize this fertilizer as a nitrogenous fertilizer with a releasing which is slower than that of the same nitrogenous components, and preferably with respect to urea.

The thus formulated fertilizer can contain, in addition to nitrogen, also other macroelements (such as phosphorus and potassium), secondary elements (calcium, magnesium and sulphur) and microelements (boron, cobalt, copper, iron, manganese, molybdene, selenium and zinc), thereby providing other embodiments of the invention.

To that end it is possible to add the above mentioned elements in the form of oxides, acids or salts.

All the above mentioned elements can be already present in the inventive organic extracts or they can be added, in several portions during the formulation step.

The fertilizer of the invention, thanks to its efficacy, can be employed in low amounts and also localized in proximity to the plants, without toxic phenomena.

The following examples are provided only for illustration purposes of the present invention and must not be taken as limiting the scope of protection, which is defined by the enclosed claims.

### EXAMPLE 1

The following raw materials are metered in a mixer:
1) a suitable urea-formaldehyde resin at 60% of dry substance in a rate of 116.66 w/w;
2) blood meal in a rate of 10 w/w;
3) a tannin and non tannin organic extract at 45% of dry substance in a rate of 44.44 w/w;

This mixture is dried in a nozzle atomizer in an equicurrent of hot air.

The ontained dry product is in the form of 0.5 mm microgranules and has the following composition based on the dry substance: 30% of nitrogen, of which 1% organic, and 13% of organic carbon.

### EXAMPLE 2

The following raw materials are metered in a mixer:
1) a suitable urea-formaldehyde resin at 55% of dry substance in a rate of 145.45 w/w;
2) blood meal in a rate of 8 w/w;
3) a tannin and non tannin organic extract at 45% of dry substance in a rate of 26.66 w/w.

The above mentioned mixture is dried in a nozzle atomizing device, with a co-current hot air stream.

The obtained dried product is in the form of microgranules having a size of 0.5 mm and has the following composition based on the dry substance: 33% nitrogen, of which 1% organic nitrogen, and 8% organic carbon.

### EXAMPLE 3

The following raw materials are mixed in a mixer:
1) a suitable urea-formaldehyde resin at 55% of dry substance in a rate of 127.27 w/w;
2) blood meal in a rate of 8 w/w;
3) a tannin and non tannin organic extract at 45% of dry substance in a rate of 26.66 w/w.
4) a phosphorus salt (monoammonium phosphate) in a rate of 10 w/w.

This mixture is dried in a nozzle atomizing device in a hot air co-current stream.

The obtained dried product is in the form of microgranules having a size of 0.5 mm and has the following composition based on the dry substance: 30% of nitrogen, of which 1% organic and 1% ammoniac; 8% of organic carbon and 6% of P₂O₂ (phosphoric anhydride).

1. A method for the preparation of highly efficient, low pollution, slowly nitrogen releasing granular organic-mineral fertilizers, characterized in that it comprises an initial mixing step, in the presence of water, of: a natural organic nitrogen source, a source of synthetic nitrogen and tannin and non tannin organic extracts and subsequently a drying step of the mixture thus obtained.

2. The method, according to the preceding claim, wherein the natural organic nitrogen can derive from: dry blood, meat meal and other animal derivatives, such as for example feather meal, horn and nail residues, bone meal, casein, proteinic hydrolysates or their mixtures in all proportions.

3. The method, according to claims 1 and 2, wherein the source of natural organic nitrogen can vary from 0.1% to 50% by dry weight and preferably between 3 and 20%.

4. The method, according to claim 1, wherein the synthetic nitrogen can derive from: urea and its adducts, condensates of the urea with an aldehyde, ammoniac salts or their mixtures in all proportions.

5. The method, according to the preceding claim, wherein the condensates of the urea with aldehyde and be: urea-formaldehyde, crotonylidendiurea or isobutylidendiurea.

6. The method, according to claims 1 and 4, wherein the source of the synthetic nitrogen can vary from 1 to 90% by dry weight and preferably between 50 and 85%.

7. The method, according to claim 1, wherein the source of tannin and non tannin organic extracts can vary from 1 to 50% by dry weight and preferably between 5 and 30%.

8. The method, according to one or more of the preceding claims, wherein drying can be realized with the spray-dry system (atomizer) with nozzles or turbine.

9. The method, according to one or more of the preceding claims, wherein drying can be realized in a granulation rotating drum.

10. The method, according to one or more of the preceding claims comprising a compressing and/or pelletizing step.

11. The method, according to one or more of the preceding claims, characterized in that it comprises the step of introduction of one or more elements chosen from phosphor, potassium, sulphur, magnesium, calcium, boron, cobalt, copper, iron, manganese, molybdenum, selenium and zinc, present singly or mixtures in all proportions.

12. The method, according to one or more of the preceding claims, characterized in that the concentrations of phosphor, expressed as P₂O₅, is comprised between 0.1 and 40% and preferably between 3 and 15%.

13. The method, according to one or more of the preceding claims, characterized in that the concentration of potassium, expressed as K₂O, is comprised between 0.1 and 20% and preferably between 1 and 10%.

14. The method, according to one or more of the preceding claims, characterized in that the fertilizer has a granulometry comprised between 0.1 and 4.00 mm diameter, and preferably between 0.4 and 1.2 mm diameter.

15. The method of preparation of a highly efficient, low pollution, slowly nitrogen releasing granular organic-mineral formulation, based on dry blood, tannin and non tannin organic extracts and synthesized nitrogen from methylene-urea, to which the following can be added: nitrogen in various forms, phosphor, potassium, calcium, magnesium, sulphur, boron, iron, copper, manganese, zinc, molybdenum, cobalt and selenium in all proportions.

16. The method of preparation of a fertilizer, according to one or more of the preceding claims, applied directly to the soil and to cultures.

17. The method, according to one or more of the preceding claims, characterized in that it comprises one or more of the described characteristics.
